(19) United States
(12) Patent Application Publication
(10) Pub. No.: US 2019/0312476 A1
(43) Pub. Date: Oct. 10, 2019

(54) MOTOR

(71) Applicant: MABUCHI MOTOR CO., LTD., Chiba (JP)

(72) Inventors: Hideki MURAKAMI, Chiba (JP); Masaaki MIYASAKA, Chiba (JP)

(21) Appl. No.: 16/051,488

(22) Filed: Aug. 1, 2018

(30) Foreign Application Priority Data
Apr. 6, 2018 (JP) 2018-074137

(51) Int. Cl. H02K 3/18; H02K 1/27; H02K 1/26; H02P 6/10; H02K 23/34

(52) U.S. Cl. CPC H02K 3/18; H02K 1/276; H02K 1/16; H02P 6/10; H02K 23/34; H02K 1/265

(57) ABSTRACT

Provided is a motor having an increased output. The motor includes: an armature including a plurality of non-wound teeth and a plurality of wound teeth having windings wound thereon, the teeth being circumferentially alternately arranged about an axis; and a field magnet including a plurality of magnets arranged side by side circumferentially so as to oppose one of an inner or an outer periphery of the armature, the field magnet being supported about the axis so as to be rotatable relative to the armature. The field magnet is provided with rotating force by sequentially switching a magnetic flux that flows through the non-wound teeth and the wound teeth due to energization of the windings of the armature. The wound teeth include a proximal-end portion having a circumferential width greater than a circumferential width of a proximal-end portion of the non-wound teeth.

### BACKGROUND

### 1. Technical Field

The present invention relates to a motor.

### 2. Description of the Related Art

For example, an inner-rotor brushless motor has the following construction. A stator (armature) is disposed in a casing, and a rotor (field magnet) having magnets is rotatably supported on the inner peripheral side of the stator. The stator has a plurality of teeth formed at regular intervals circumferentially and protruding toward the inner peripheral side, with slots providing openings and formed between the teeth. Through the slots, three-phase windings for U-phase, V-phase, and W-phase are wound on the respective teeth, forming the coils for the respective phases.

The coils of the respective phases on the stator are successively energized at times corresponding to the rotation angle of the rotor. Correspondingly, magnetic fluxes that flow through the respective teeth are sequentially switched to provide the rotor with rotating force.

In the above brushless motor, the efficiency of winding operation is low because the windings are wound on all of the teeth. Further, a gap or corresponding insulation is required between the coils on adjacent teeth in the same slot. In the case of an integrated stator core, clearance for the coils on adjacent teeth and a winding nozzle is required, leaving room for improvement in terms of coil space factor in the slot.

To address the above, a brushless motor has been put to practical use in which non-wound teeth that do not have windings and that mostly function only as a magnetic path are disposed between the wound teeth having the windings. In the brushless motor, the winding of a single tooth is disposed in each slot. This eliminates the need for providing insulation between different windings or maintaining clearance with respect to the coils of adjacent teeth. Thus, the space factor of coils in the slot and therefore motor efficiency can be improved. In addition, the number of teeth to be wound is halved, so that the efficiency of winding operation is also improved.

In a search for even higher efficiency, JP-A-2009-118611, for example, discloses an improvement in the shape of the non-wound teeth (which the literature refers to as “auxiliary poles”). The improvement involves increasing the magnetic path width of the non-wound teeth by effectively utilizing a dead space formed in each slot.

### SUMMARY

However, there is still room for improvement in terms of the output of a brushless motor. This problem also applies to brushed motors.

The present invention has been made to address the above problem. An object of the present invention is to provide a motor having an increased output.

In order to achieve the object, a motor according to the present invention includes an armature including a plurality of non-wound teeth and a plurality of wound teeth having windings wound thereon, the plurality of non-wound teeth and the plurality of wound teeth being circumferentially alternately arranged about an axis; and a field magnet including a plurality of magnets arranged side by side circumferentially so as to oppose one of an inner or an outer periphery of the armature, the field magnet being supported about the axis so as to be rotatable relative to the armature. The field magnet is provided with rotating force by sequentially switching a magnetic flux that flows through the non-wound teeth and the wound teeth due to energization of the windings of the armature. The wound teeth include a proximal-end portion having a circumferential width greater than a circumferential width of a proximal-end portion of the non-wound teeth.

In the thus configured motor, among the plurality of wound teeth, circumferentially adjacent wound teeth are provided with windings that are energized with mutually different phases of U-phase, V-phase, and W-phase, for example. For example, a magnetic flux that flows from a magnet opposing a wound tooth for U-phase (which may be hereafter referred to as “first wound tooth”) and through the first wound tooth passes through the non-wound teeth circumferentially adjacent to the first wound tooth, and reaches the magnets opposing the non-wound teeth. In this case, the non-wound teeth circumferentially adjacent to the first wound tooth are respectively arranged on one side and the other side circumferentially. Thus, approximately one-half of the magnetic flux flowing out of the first wound tooth passes through each of the non-wound teeth.

With respect to the first wound tooth, there are also wound teeth (which may be hereafter referred to as “second wound teeth”) arranged on the opposite sides across the non-wound teeth circumferentially. The magnetic fluxes linking the windings wound on the second wound teeth have mutually different phases from the magnetic flux linking the winding wound on the first wound tooth. Accordingly, the amounts of magnetic fluxes flowing through these wound teeth are maximized in different periods. That is, when the amount of magnetic flux flowing through the first wound tooth is maximized, the amount of magnetic fluxes flowing through the second wound teeth is not so much.

Thus, by making the circumferential width of the proximal-end portion of the first wound tooth greater than the circumferential width of the proximal-end portion of a pair of respective non-wound teeth, the magnetic flux density through the first wound tooth, and the magnetic flux density through the pair of respective non-wound teeth can be made more uniform.

Then, it becomes possible, for example, to increase the winding on the first wound tooth by an amount corresponding to the decrease in the width of the pair of respective non-wound teeth relative to the width of the first wound tooth, or to increase the number of sets of the wound teeth and the non-wound teeth.

Accordingly, by making the circumferential width of the proximal-end portion of the wound teeth greater than the circumferential width of the proximal-end portion of the non-wound teeth, the output of the motor can be increased.

In another embodiment, preferably, the circumferential width of the proximal-end portion of the non-wound teeth may have a ratio of not less than 0.58 and not more than 0.85 to the circumferential width of the proximal-end portion of the wound teeth.

In the thus-configured motor, if the ratio is less than 0.5, the circumferential width of the proximal-end portion of the non-wound teeth becomes narrow, and it becomes difficult for the magnetic flux to pass through the non-wound teeth. On the other hand, if the ratio is greater than 0.8, the magnetic flux density in the non-wound teeth decreases, resulting in a decrease in efficiency. By setting the ratio in the range of the embodiment, the output of the motor can be more efficiently increased.

In another embodiment, preferably, a value obtained by dividing the least common multiple of a sum of the number of the plurality of non-wound teeth and the plurality of wound teeth and a number of magnetic poles of the plurality of magnets, by the number of magnetic poles of the plurality of magnets may be an odd number.

The number of magnetic poles of the plurality of magnets herein means a total number (sum) of the magnetic poles with which the plurality of magnets is provided and which oppose the armature.

In the thus-configured motor, when the sum of the number of the plurality of non-wound teeth and the number of the plurality of wound teeth is 2N (N is a natural number), it is considered, magnetically, that there are N sets of the wound teeth and the non-wound teeth. In this case, the least common multiple of the number of magnetic poles of the plurality of magnets and N corresponds to the fundamental order of cogging torque. It is also known that the higher the order of cogging torque, the smaller the cogging torque tends to become.

When the value obtained by dividing the least common multiple by the number of magnetic poles of the plurality of magnets is an odd number, the least common multiple of the number of magnetic poles of the plurality of magnets and N, and the least common multiple of the number of magnetic poles of the plurality of magnets and 2N become equal to each other, and the least common multiple of the number of magnetic poles of the plurality of magnets and N becomes a relatively large value. On the other hand, when the value obtained by dividing the least common multiple by the number of magnetic poles of the plurality of magnets is an even number, the least common multiple of the number of magnetic poles of the plurality of magnets and N becomes smaller than the least common multiple of the number of magnetic poles of the plurality of magnets and 2N, and the least common multiple of the number of magnetic poles of the plurality of magnets and N becomes a relatively small value.

Thus, when the value obtained by dividing the least common multiple by the number of magnetic poles of the plurality of magnets is an odd number, it becomes possible to make the least common multiple of the number of magnetic poles of the plurality of magnets and N a relatively large value, and to increase the fundamental order of cogging torque, whereby the cogging torque of the motor can be reduced.

In another embodiment, preferably, the field magnet may be disposed on an outer peripheral side of the armature. The non-wound teeth of the armature may protrude toward an outer peripheral side from the axis, may include an outer peripheral end opposing the magnets of the field magnet, and may include a magnetic path enlarged-portion that is circumferentially enlarged on the outer peripheral end side.

In the thus-configured motor, the field magnet (rotor) having the magnets is disposed on the outer peripheral side of the armature, so that the motor is configured as an outer-rotor type. Because the respective non-wound teeth include the magnetic path enlarged-portion that is circumferentially enlarged on the outer peripheral end side, a magnetic path width for the non-wound teeth is ensured, making it possible to decrease magnetic flux density and to reduce core iron loss.

In another embodiment, preferably, the field magnet may be disposed on an inner peripheral side of the armature. The non-wound teeth of the armature may protrude toward the inner peripheral side from the axis, may include an inner peripheral end opposing the magnets of the field magnet, and may include a magnetic path enlarged-portion that is circumferentially enlarged on an outer peripheral end side.

In the thus-configured motor, the field magnet (rotor) is disposed on the inner peripheral side of the armature. Thus, the motor is configured as an inner-rotor type. Because the respective non-wound teeth include the magnetic path enlarged-portion that is circumferentially enlarged on the outer peripheral end side, a magnetic path width for the non-wound teeth is ensured, making it possible to decrease magnetic flux density and reduce core iron loss.

According to the motor of the present invention, an increased output can be obtained.

### BRIEF DESCRIPTION OF THE DRAWINGS

FIG. 1 is a side view of an outer-rotor brushless motor according to a first embodiment of the present invention;

FIG. 2 is a sectional view taken along line II-II of FIG. 1, illustrating the inside of the brushless motor;

FIG. 3 is a transverse sectional view for describing an operation of the brushless motor;

FIG. 4 is a diagram illustrating changes in magnetic fluxes linking the respective coils of the brushless motor, with respect to time;

FIG. 5 is a transverse sectional view describing an operation of the brushless motor;

FIG. 6 is a transverse sectional view describing an operation of the brushless motor;

FIG. 7 is a diagram illustrating changes in a cogging torque ratio relative to a proximal-end portion width ratio of teeth;

FIG. 8 is a transverse sectional view of a brushless motor in a modification of the first embodiment of the present invention;

FIG. 9 is a transverse sectional view of an inner-rotor brushless motor according to a second embodiment of the present invention;

FIG. 10 is a transverse sectional view of an inner-rotor brushed motor according to a third embodiment of the present invention; and

FIG. 11 is a longitudinal sectional view of an inner-rotor brushed motor according to a third embodiment of the present invention.

### DESCRIPTION OF THE EMBODIMENTS

### First Embodiment

In the following, an outer-rotor brushless motor according to an embodiment of the present invention will be described.

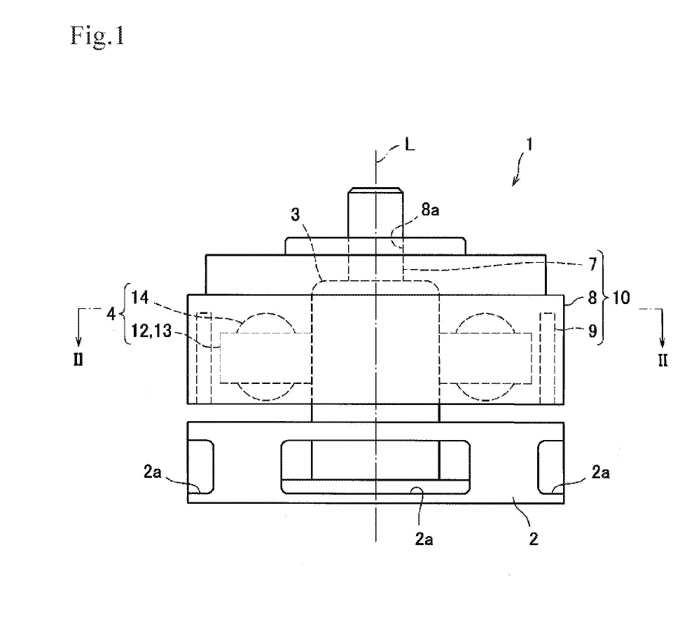

For description purposes, references to “top” or “upper” and “bottom” or “lower” will be made with reference to the attitude of a brushless motor illustrated in FIG. 1.

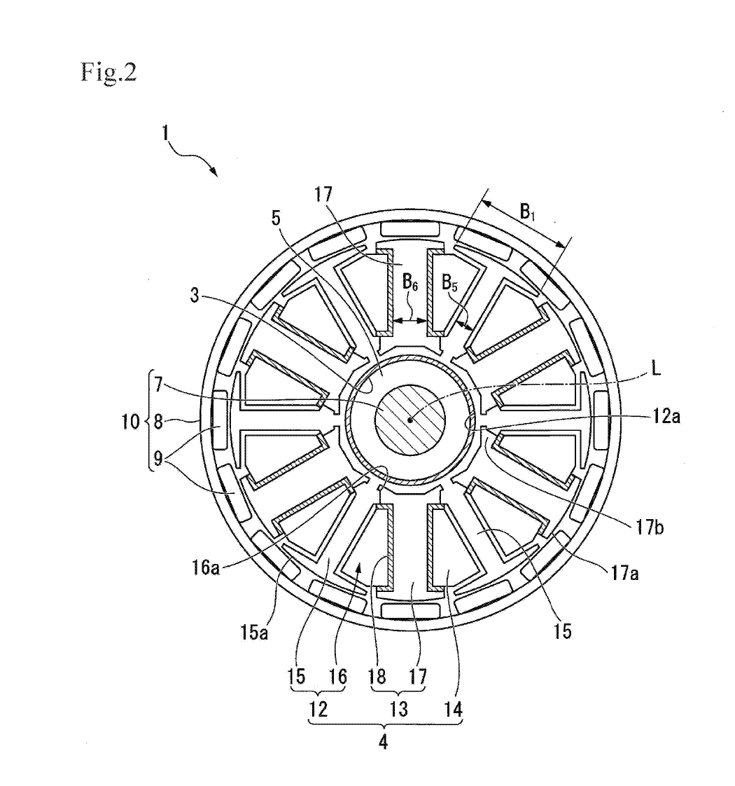

As illustrated in FIG. 1 and FIG. 2, the brushless motor 1 (hereafter simply “motor 1”) includes a base portion 2 which has a cylindrical cup-shape with an opening at the top. The base portion 2 has a peripheral surface formed with a plurality of lightening holes 2a for weight reduction. While not illustrated in the drawings, the base portion 2 has a lower surface in which a plurality of female screw holes is formed. The female screw holes are used when the motor 1 is fixed to an object (not illustrated) to which the motor 1 is to be fixed.

At the center of the base portion 2, a bearing holder 3 is vertically provided, and a stator (armature) 4 is fixed to the outer periphery of the bearing holder 3.

As illustrated in FIG. 2, a bearing 5 is disposed in the bearing holder 3. The bearing 5 rotatably supports the rotating shaft 7 about an axis L along an upper-lower direction. As illustrated in FIG. 1 and FIG. 2, an upper part of the rotating shaft 7 is inserted into and fixed in a shaft hole 8a of a cylindrical cup-shaped rotor case 8 with a lower opening. The rotor case 8 is supported via the rotating shaft 7 in a relatively rotatable manner on the outer peripheral side of the stator 4.

The rotor case 8, in order to function as a yoke of the rotor 10 as will be described below, is made from a magnetic material, such as magnetic steel sheet, pure iron, or similar ferromagnetic and soft-magnetic metal material. The rotor case 8 is fabricated by drawing using a press.

The rotating shaft 7 protrudes from above the rotor case 8. While not illustrated in the drawings, the rotor case 8 has female screw holes formed at four equally divided locations about the rotating shaft 7. An object to be driven by the motor 1 is fitted onto the rotating shaft 7 using the female screw holes. In this case, the object to be driven is aligned with the axis L and fixed over the rotor case 8. On the inner peripheral surface of the rotor case 8, a total of 16 magnets 9 are circumferentially arranged side by side at regular intervals. The rotating shaft 7, the rotor case 8, and the magnets 9 make up a rotor (field magnet) 10.

In the present example, each of the magnets 9 has one magnetic pole on the side opposing the stator 4. In this case, the number of magnetic poles of the plurality of magnets 9, i.e., the 16 magnets 9, is 16. When each magnet has P (P is a natural number) magnetic poles, the number of magnetic poles of the plurality of magnets is a value obtained by multiplying the number of magnets by P.

The 16 magnets 9 having a total of 16 magnetic poles may be integrally configured to provide a configuration in which a single magnet has 16 magnetic poles.

The configuration of the stator 4 will be described.

The stator 4 includes a fixed core 12 fixed to the bearing holder 3, six divided cores 13 attached to the fixed core 12, and coils 14 for the respective phases of U, V, and W.

The fixed core 12 comprises a plurality of steel sheets laminated in the upper-lower direction. The fixed core 12 has a fitting hole 12a penetrating therethrough at the center. The fixed core 12 is fixed to the bearing holder 3 by fitting the fitting hole 12a with the outer peripheral surface of the bearing holder 3. In circumferentially equally divided six locations about the center of the fixed core 12, non-wound teeth 15 are respectively integrally formed. The respective non-wound teeth 15 protrude on the outer peripheral side from the axis L. In plan view, each of the non-wound teeth 15 includes an outer peripheral end 15a (opposing surface of the present invention) with a circumferentially increased width, forming a T-shape. The proximal-end portion (end portion opposite from the outer peripheral end 15a) of the non-wound teeth 15 has a radially extending rectangular shape. The outer peripheral end 15a is opposed to the magnets 9 via a predetermined clearance on the inner peripheral side of the magnets 9 of the rotor 10.

As illustrated in FIG. 2, slots 16 are formed between the respective non-wound teeth 15. The slots 16 are open on the outer peripheral side of the fixed core 12. At the center of the non-wound teeth 15 positioned on both sides at the bottom portion in each slot 16, a dovetail groove 16a is formed. The dovetail groove 16a is for fixing the divided cores 13 to the fixed core 12.

Each of the divided cores 13 includes a wound tooth 17 on which a winding is wound, and a bobbin 18 for insulation. Each of the wound teeth 17 includes a plurality of steel sheets laminated in the upper-lower direction. The wound teeth 17 have a circumferentially increased width on one end, forming a T-shape in plan view, as in the case of the non-wound teeth 15. The proximal-end portion (end portion opposite from an outer peripheral end 17a which will be described later) of the wound teeth 17 has a radially extending rectangular shape. The other end of the wound teeth 17 is integrally formed with a dovetail 17b. Each of the wound teeth 17 is disposed in each slot 16 of the fixed core 12. Each of the wound teeth 17 has its dovetail 17b on the other end fitted in each dovetail groove 16a of the fixed core 12. Each of the wound teeth 17 is fixed at the center of the non-wound teeth 15 positioned on both sides in each slot 16.

Thus, the one end side of each of the wound teeth 17 having an increased width, i.e., the outer peripheral end 17a (opposing surface of the present invention), is opposed to the inner peripheral side of the magnets 9 of the rotor 10 via a predetermined clearance. Both circumferential sides of the outer peripheral end 17a are slightly spaced apart from the outer peripheral end 15a of the adjacent non-wound teeth 15.

Accordingly, a plurality of non-wound teeth 15 and a plurality of wound teeth 17 are alternately arranged circumferentially about the axis L.

In the present embodiment, the wound teeth 17 have a circumferential width B6 of the proximal-end portion thereof which is greater than a circumferential width B5 of the proximal-end portion of the respective non-wound teeth 15. In the following, the ratio of width B6 to width B5 will be referred to as a proximal-end portion width ratio of teeth. In the present embodiment, the proximal-end portion width ratio of teeth is not more than one.

In the area between the dovetail 17b of each of the wound teeth 17 and the outer peripheral end 17a, the tubular bobbin 18, which is made of an insulating synthetic resin material, is fitted. The bobbin 18 has flanges formed on both ends thereof. The flanges are respectively in contact with the end face of the dovetail 17b and the end face of the outer peripheral end 17a.

The wound teeth 17 of the respective divided cores 13 are wound with the windings for the respective phases in the order of U, V, and W circumferentially about the axis L. The respective wound teeth 17 and the windings are retained in an insulated manner by means of the bobbin 18. While not illustrated in the drawings, the windings for the respective phases are connected via crossover wiring. In this way, the windings for the respective phases form the coils 14 for the respective phases of U, V, and W.

While not illustrated in the drawings, the motor 1 is supplied with electric power via a power feed cable. At times depending on the rotation angle of the rotor 10, the coils 14 for the respective phases on the stator 4 are successively energized by a sensorless drive system. In accordance with the energization of the coils 14 for the respective phases, the flow of magnetic flux through the respective wound teeth 17 and the respective non-wound teeth 15 is sequentially switched, whereby the rotor 10 is provided with rotating force.

In the motor 1 thus configured, the number of magnetic poles of the plurality of magnets 9 (hereafter referred to as “pole number”) is 16. The sum of the number of the plurality of non-wound teeth 15 and the number of the plurality of wound teeth 17 (the number of slots formed by the teeth 15, 17; hereafter referred to as “slot number”) is 12. That is, the motor 1 is a motor where the pole number is 16 and the slot number is 12.

As in the motor 1 of the present embodiment, it is preferable that the value obtained by dividing the least common multiple of the slot number and the pole number by the pole number be an odd number. Specifically, in the motor 1 of the present embodiment, the least common multiple of the slot number 12 and the pole number 16 is 48. The value obtained by dividing the least common multiple by the pole number 16 is three, which is an odd number.

Other examples of the motor in which the value obtained by dividing the least common multiple of the slot number and the pole number by the pole number is an odd number are a motor where the pole number is 24 and the slot number is 18, and a motor where the pole number is 40 and the slot number is 18.

The details of the magnetic flux linking the teeth 15, 17 of the motor 1 thus configured will be described.

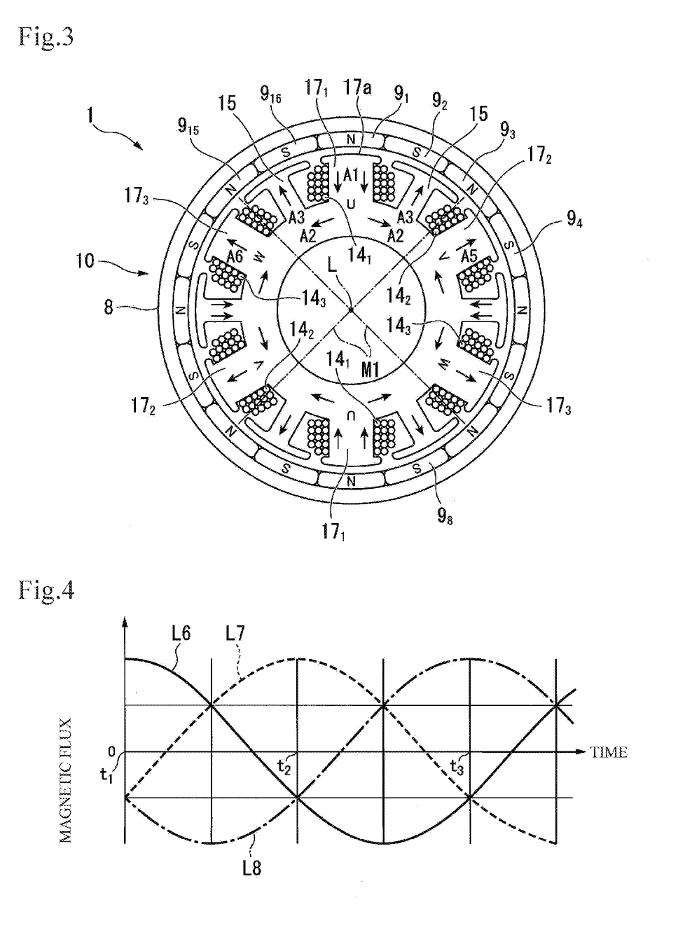

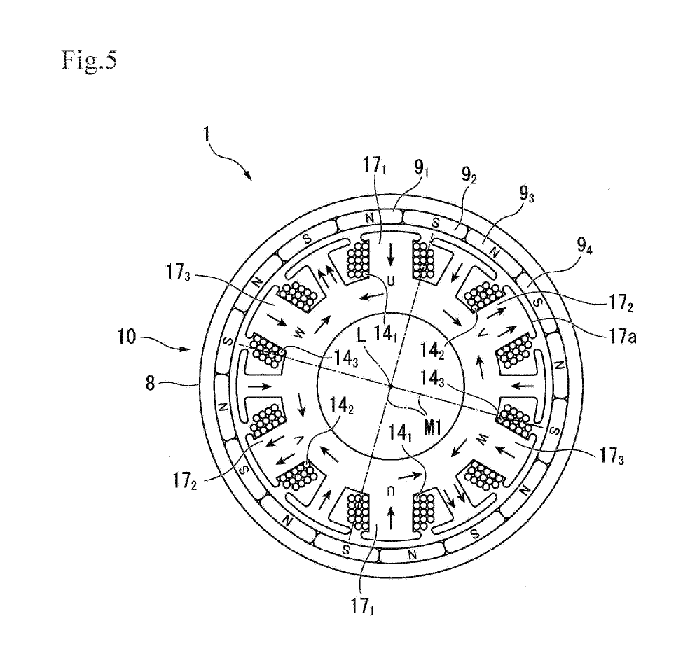

As illustrated in FIG. 3, the coils 14 for the respective phases of U, V, and W may also be referred to as coils 14₁, 14₂, 14₃, respectively. In FIG. 3, and FIG. 4 and FIG. 5 which will be described later, the original notation of the sign “14” for the coils 14, for example, is omitted. Also, in these figures, the magnetic flux is represented by arrows.

The coils (windings) 14₁, 14₂, 14₃ are linked by magnetic fluxes illustrated in FIG. 4, for example. In FIG. 4, the horizontal axis shows time and the vertical axis shows magnetic flux. For example, a solid line L6 indicates a magnetic flux linking the coil 14₁. A dotted line L7 indicates a magnetic flux linking the coil 14₂. A dashed and single-dotted line L8 indicates a magnetic flux linking the coil 14₃. The magnetic fluxes linking the coils 14₁, 14₂, 14₃ have different phases.

The wound teeth 17 to which the coil 14₁ for U-phase is attached are referred to as wound teeth 17₁. Similarly, the wound teeth 17 to which the coil 14₂ for V-phase is attached are referred to as wound teeth 17₂. The wound teeth 17 to which the coil 14₃ for W-phase is attached are referred to as wound teeth 17₃.

As illustrated in FIG. 3, among the plurality of magnets 9, the magnet 9 arranged in the direction of 12 o'clock with respect to the axis L is referred to as a magnet 9₁. The magnets 9 arranged in clockwise direction about the axis L with respect to the magnet 9₁ are referred to as magnets 9₂ to 9₁₆. The magnets 9₁, 9₃, . . . , and 9₁₅ are N poles, and the magnets 9₂, 9₄, . . . , and 9₁₆ are S poles.

In the state illustrated in FIG. 3, the magnetic flux linking the coil 14₁ for U-phase, as at time t₁ in FIG. 4, has a maximum value.

At time t₁, compared with the magnitude of the magnetic flux linking the coil 14₁ for U-phase, the magnitude of the magnetic flux linking the coil 14₂ for V-phase and the magnitude of the magnetic flux linking the coil 14₃ for W-phase are small.

As indicated by arrows A1 in FIG. 3, the magnetic flux out of the magnet 9₁ passes through the wound tooth 17₁ and flows out of the wound tooth 17₁, as indicated by arrows A2. The magnetic flux flows through the non-wound teeth 15 circumferentially adjacent to the wound tooth 17₁, as indicated by arrows A3, and flows into the magnets 9₂, 9₁₆. In this case, the non-wound teeth 15 circumferentially adjacent to the wound tooth 17₁ are respectively arranged on one side and the other side circumferentially. Accordingly, approximately one-half of the magnetic flux flowing out of the wound tooth 17₁ passes through each of the respective non-wound teeth 15.

On the opposite sides circumferentially of the wound tooth 17₁ across the non-wound teeth 15, there are also the wound teeth 17₂, 17₃ arranged. However, at time t₁, the magnetic fluxes linking the coils 14₂, 14₃ attached to the wound teeth 17₂, 17₃ have mutually different phases from that of the magnetic flux linking the coils 14₁ attached to the wound tooth 17₁. Accordingly, the amounts of magnetic fluxes of the wound teeth 17₁, 17₂, 17₃ are maximized in different periods. That is, when the amount of magnetic flux flowing out of the wound tooth 17₁ is maximized, the amounts of magnetic fluxes flowing out of the wound teeth 17₂, 17₃ indicated by arrows A5, A6 are not so much.

Then, it becomes possible, for example, to increase the winding on the wound tooth 17₁, or to increase the number of the sets of the wound teeth 17 and the non-wound teeth 15. Thus, by making the circumferential width B6 of the proximal-end portion of the wound teeth 17 greater than the circumferential width B5 of the proximal-end portion of the respective non-wound teeth 15, the output of the motor 1 can be increased.

In FIG. 3, boundary lines M1 represent magnetic flux boundary lines. Due to the symmetric configuration of the motor 1, there is only a little magnetic flux that crosses the boundary lines M1. That is, the magnetic flux can be considered with reference to a set of the three teeth 15, 17 including a single wound tooth 17 and a pair of non-wound teeth 15 circumferentially adjacent to the wound tooth 17, as a unit of reference.

When, at time t2 in FIG. 4, the rotor 10 has rotated in anticlockwise direction from the state of FIG. 3 by 7.5° about the axis L, as illustrated in FIG. 5, the magnetic flux linking the coil 14₂ for V-phase has a maximum value.

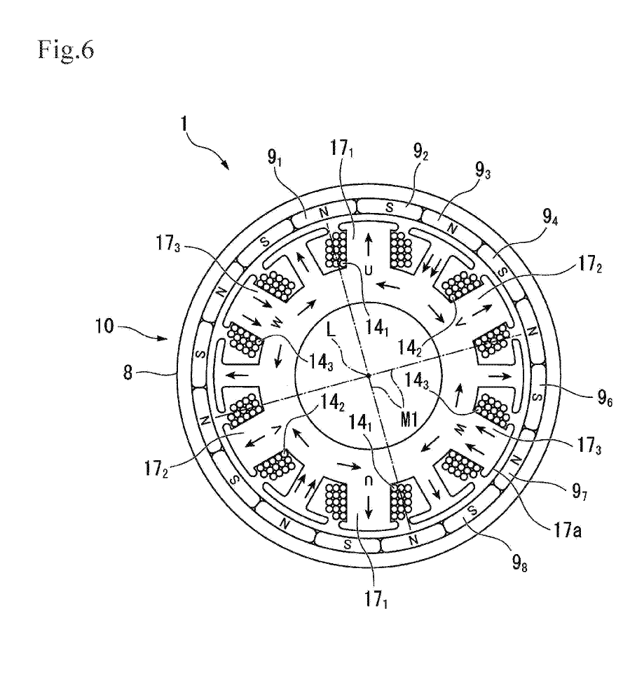

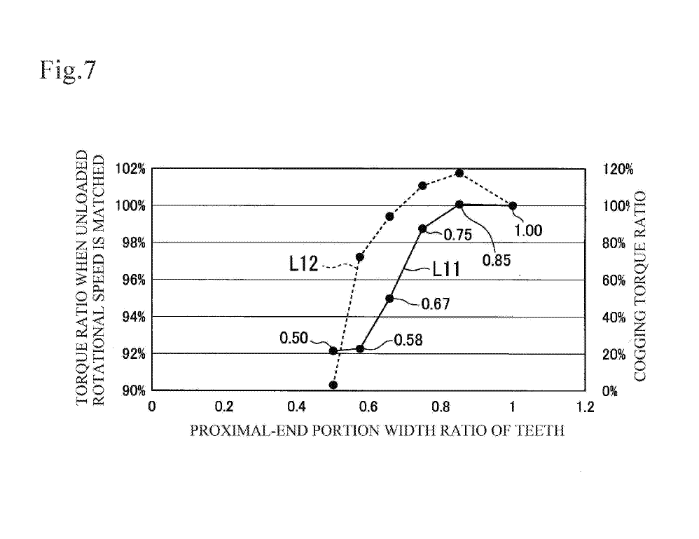

Further, when, at time t3 in FIG. 4, the rotor 10 has rotated in anticlockwise direction from the state of FIG. 3 by 15° about the axis L, as illustrated in FIG. 6, the magnetic flux linking the coil 14₃ for W-phase has a maximum value.

Thereafter, the same steps are repeated, and the rotor 10 rotates in anticlockwise direction about the axis L.

As described above, in the motor 1 of the present embodiment, the width B6 of the proximal-end portion of the wound teeth 17 is greater than the width B5 of the proximal-end portion of the respective non-wound teeth 15. Thus, it becomes possible to wind more winding on the wound teeth 17₁, or to increase the number of the sets of the wound teeth 17 and the non-wound teeth 15, thereby increasing the output of the motor 1.

It also becomes possible to increase the output of the motor 1 easily and inexpensively.

In the motor 1, the value obtained by dividing the least common multiple of the slot number (the sum of the number of the plurality of non-wound teeth 15 and the number of the plurality of wound teeth 17) and the pole number (the number of magnetic poles of the plurality of magnets 9) by the pole number is an odd number.

When the slot number of the motor 1 is 2N (N is a natural number; 12 in the present embodiment), it is considered, magnetically, that there are N sets of the wound teeth 17 and the non-wound teeth 15 (six sets in the present embodiment). In this case, the least common multiple of the pole number and N corresponds to the fundamental order of cogging torque. It also known that the higher the cogging torque order, the smaller the cogging torque tends to become.

When the value obtained by dividing the least common multiple of the slot number and the pole number by the pole number is an odd number, the least common multiple of the pole number and N and the least common multiple of the pole number and 2N become equal to each other, and the least common multiple of the pole number and N becomes a relatively large value. On the other hand, when the value obtained by dividing the least common multiple of the slot number and the pole number by the pole number is an even number, the least common multiple of the pole number and N becomes smaller than the least common multiple of the pole number and 2N, and the least common multiple of the pole number and N becomes a relatively small value.

Thus, when the value obtained by dividing the least common multiple of the slot number and the pole number by the pole number is an odd number, it becomes possible to increase the fundamental order of cogging torque by making the least common multiple of the pole number and N a relatively large value, whereby the cogging torque of the motor 1 can be reduced.

Because an increase in the output of the motor 1 and a decrease in cogging torque can be achieved, the motor 1 may be used for applications where smooth movements are required, such as in robots.

With reference to FIG. 7, the results of determining changes in cogging torque ratio when the proximal-end portion width ratio of teeth is changed in the motor will be described. In FIG. 7, the horizontal axis shows the proximal-end portion width ratio of teeth, and the vertical axis on the right shows cogging torque ratio. A solid line L11 indicates the results of cogging torque. The cogging torque ratio herein means the ratio of cogging torque to the cogging torque of a motor in which the proximal-end portion width ratio of teeth is one. In FIG. 7, the proximal-end portion width ratio of teeth at measurement points is indicated by numerical values. For example, among the measurement points, the maximum proximal-end portion width ratio of teeth is 1.00.

When the proximal-end portion width ratio of teeth is less than 0.85, the cogging torque ratio gradually decreases. Particularly, when the proximal-end portion width ratio of teeth is not more than 0.75, the cogging torque ratio is greatly decreased.

Accordingly, by setting the proximal-end portion width ratio of teeth to be not more than 0.75, the cogging torque of the motor 1 can be decreased.

In FIG. 7, the torque ratio when the unloaded rotational speed with respect to the proximal-end portion width ratio of teeth is matched is indicated by the vertical axis on the left. A dotted line L12 indicates the results of the torque ratio when the unloaded rotational speed is matched. The torque ratio when the unloaded rotational speed is matched refers to the ratio of a torque when the unloaded rotational speed is matched relative to a torque when the unloaded rotational speed of a motor in which the proximal-end portion width ratio of teeth is one is matched.

When the proximal-end portion width ratio of teeth is changed, the rotational speed of the motor is changed, even if the same voltage is applied to the motor. In order to match the unloaded rotational speed, under the condition that the space factor of the wound teeth 17 is constant, the diameter of the winding and the number of turns were adjusted, and the maximum torque (stalling torque) of the motor was compared.

When the proximal-end portion width ratio of teeth is small, the circumferential width B5 of the proximal-end portion of the non-wound teeth 15 becomes narrow, and it becomes harder for the magnetic flux to flow through the non-wound teeth 15, resulting in a lower torque ratio. When the proximal-end portion width ratio of teeth is not less than 0.5, the torque ratio gradually increases as the proximal-end portion width ratio of teeth increases. When the proximal-end portion width ratio of teeth is 0.85, the torque ratio has the maximum value. When the proximal-end portion width ratio of teeth exceeds 0.85, the torque ratio gradually decreases as the proximal-end portion width ratio of teeth increases.

Accordingly, in order to maintain a high torque ratio while keeping the cogging torque ratio low, the proximal-end portion width ratio of teeth is set to be not less than 0.5 and less than 1.0 and preferably not less than 0.58 and not more than 0.85.

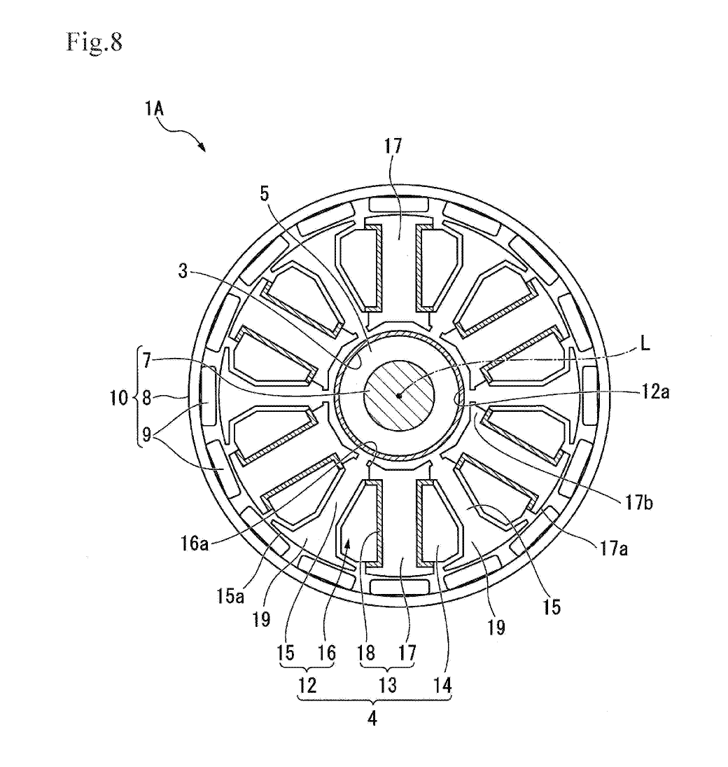

FIG. 8 illustrates a motor 1A according to a modification in which, in addition to the configuration of the motor 1 of the first embodiment, the respective non-wound teeth 15 of the stator 4 are formed with a magnetic path enlarged-portion 19. The magnetic path enlarged-portion 19 protrudes toward the outer peripheral side from the axis L, and has an outer peripheral end opposing the magnets 9 of the rotor 10. The magnetic path enlarged-portion 19 is circumferentially enlarged on the outer peripheral end side. Thus, the circumferential length of the magnetic path enlarged-portion 19 is gradually increased on the outer peripheral end side.

The circumferential width of the magnetic path enlarged-portion 19 on the outer peripheral end is smaller than a circumferential width B1 (see FIG. 2) of the outer peripheral end 15a of the non-wound teeth 15. That is, the width of the non-wound teeth 15 is increased in two stages on the outer peripheral end side due to the magnetic path enlarged-portion 19 and the outer peripheral end 15a.

In the motor 1A of the modification, the magnetic path enlarged-portion 19 ensures a magnetic path width for the non-wound teeth 15, whereby the magnetic flux density can be decreased and the core iron loss can be reduced.

When the circumferential width at the outer peripheral end of the magnetic path enlarged-portion is equal to the width B1, the width of the non-wound teeth 15 may be increased in one step on the outer peripheral end side due to the magnetic path enlarged-portion and the outer peripheral end 15a.

### Second Embodiment

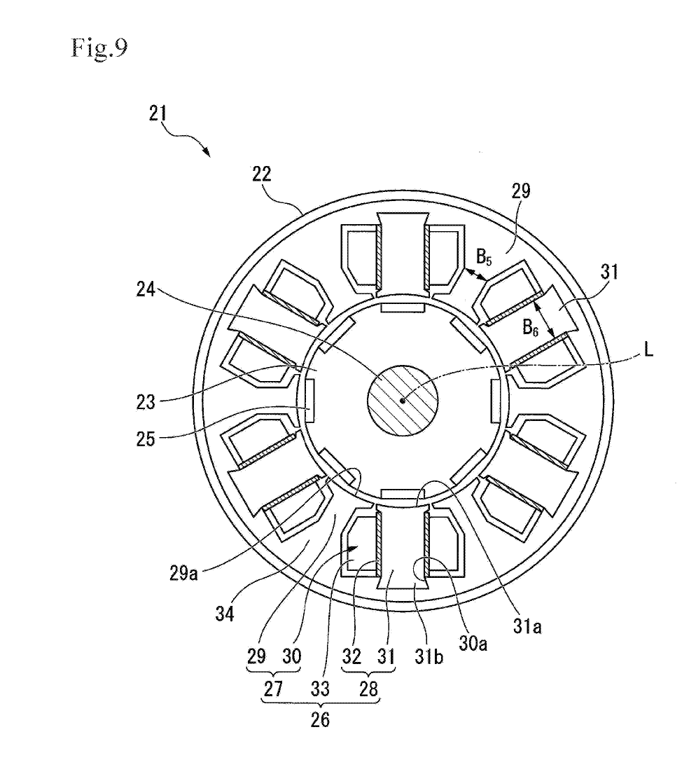

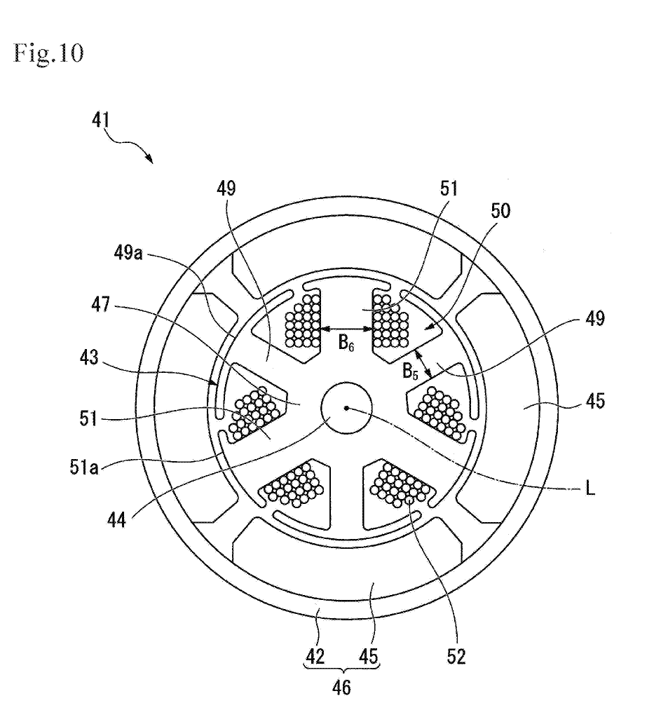

A second embodiment of the present invention will be described with reference to FIG. 9. Portions similar to those of the first embodiment are designated with similar signs and their descriptions will be omitted, focusing on different points.

FIG. 9 is a transverse sectional view of a motor 21 which is an inner-rotor brushless motor.

The motor 21 includes a casing 22 in which a rotor (field magnet) 23 is supported on a rotating shaft 24 so as to be rotatable about the axis L. The rotor 23 includes an outer peripheral surface on which eight magnets 25 are circumferentially arranged side by side, each having a single magnetic pole on an outer periphery thereof.

In the casing 22, an annular stator (armature) 26 is fitted about the axis L. The stator 26 includes a fixed core 27, six divided cores 28, and coils 33 for the respective phases. The rotor 23 is rotatably supported on the inner peripheral side of the stator 26.

The fixed core 27 is integrally formed with six non-wound teeth 29 protruding toward the inner peripheral side. In plan view, the respective non-wound teeth 29 include an inner peripheral end 29a (opposing surface of the present invention) having a circumferentially increased width, forming a T-shape. The respective non-wound teeth 29 have the inner peripheral end 29a opposing the magnets 25 on the rotor 23 side. Between the respective non-wound teeth 29, slots 30 are formed, opening on the inner peripheral side of the fixed core 27. In each of the slots 30, a dovetail groove 30a is formed.

The respective wound teeth 31 of the divided core 28 have an inner peripheral end 31a (opposing surface of the present invention) having a circumferentially increased width, forming a T-shape. The wound teeth 31 are fixed in the slots 30 with the dovetail 31b formed on the outer peripheral end fitted in the dovetail groove 30a of the fixed core 27. The wound teeth 31 have their inner peripheral ends 31a opposing the magnets 25.

Each of the wound teeth 31 has a winding wound thereon via a bobbin 32, forming coils 33 for the respective phases. The coils 33 are successively energized, whereby magnetic fluxes flow through the respective non-wound teeth 29 and the respective wound teeth 31, thereby providing the sequentially switched rotor 23 with rotating force.

In the present embodiment, the circumferential width B6 of the proximal-end portion of the wound teeth 31 is also greater than the circumferential width B5 of the proximal-end portion of the respective non-wound teeth 29.

The respective non-wound teeth 29 of the stator 26 may be formed with a magnetic path enlarged-portion 34. The magnetic path enlarged-portion 34 protrudes on the inner peripheral side toward the axis L, and has an inner peripheral end opposing the magnets 25 of the rotor 23. The magnetic path enlarged-portion 34 is circumferentially enlarged on the outer peripheral end side.

The motor 21 of the present embodiment is a motor in which the pole number is eight and the slot number is 12.

As described above, according to the present embodiment, an increased output of the motor 21 can be obtained.

Further, the magnetic path enlarged-portion 34 ensures a magnetic path width of the non-wound teeth 29, whereby the magnetic flux density can be decreased and the core iron loss can be reduced.

The motor 21 may not be provided with the magnetic path enlarged-portion 34.

### Third Embodiment

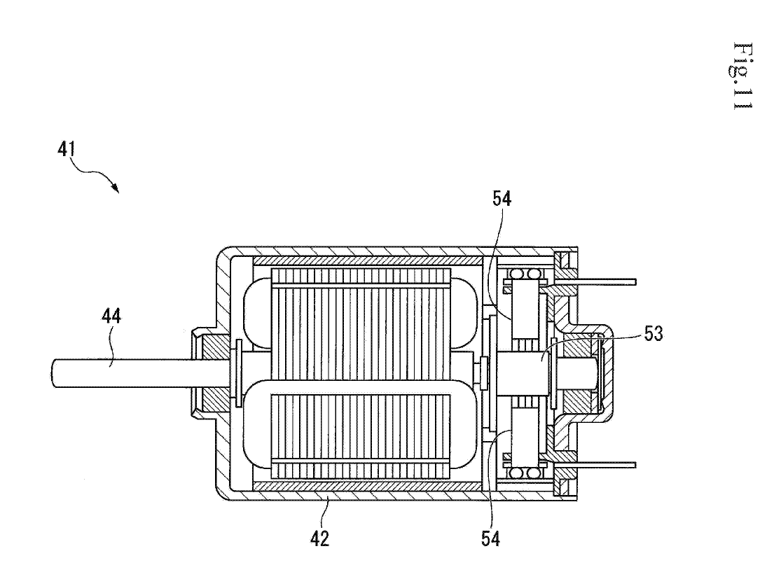

A third embodiment of the present invention will be described with reference to FIG. 10 and FIG. 11. FIG. 10 is a schematic diagram illustrating a transverse cross section of a motor 41 which is an inner-rotor brushed motor. FIG. 11 is a longitudinal (axial) sectional view of the motor 41.

As illustrated in FIG. 10, the motor 41 includes a stator (field magnet) 46 provided with a casing 42 and a magnets 45. The casing 42 has an inner peripheral surface on which four magnets 45 arranged side by side circumferentially about the axis L are adhesively fixed. Each of the four magnets 45 has a single magnetic pole on an inner periphery thereof. On the inner peripheral side of the stator 46, a rotor (armature) 43 is supported on the casing 42 by means of a rotating shaft 44 so as to be rotatable about the axis L. A rotor core 47 is fitted to the rotating shaft 44 of the rotor 43.

The rotor core 47 is formed with three non-wound teeth 49 and three wound teeth 51 protruding toward the outer peripheral side. In plan view of FIG. 10, the non-wound teeth 49 and the wound teeth 51 respectively include outer peripheral ends 49a, 51a (opposing surface of the present invention) each having a circumferentially increased width, forming a T-shape. The outer peripheral ends 49a, 51a of the respective non-wound teeth 49 and wound teeth 51 are opposed to the magnets 45 on the stator 46 side. Between the non-wound teeth 49 and the wound teeth 51, slots 50 are formed, opening on the outer peripheral side of the rotor core 47.

Each of the wound teeth 51 has a winding wound thereon via an insulation coating (not illustrated), forming the coils 52 for the respective phases. The coils 52 are connected to commutators 53 illustrated in FIG. 11. As the rotor 43 rotates, the relative position of the commutators 53 and brushes 54 provided on the casing 42 is changed, whereby the respective phases of the coil 52 are successively energized. Thus, the magnetic fluxes that flow through the non-wound teeth 49 and the wound teeth 51 are sequentially switched, thereby providing the rotor 43 with rotating force.

As illustrated in FIG. 10, in the present embodiment, the circumferential width B6 of the proximal-end portion of the respective wound teeth 51 is also greater than the circumferential width B5 of the proximal-end portion of the respective non-wound teeth 49. In the present embodiment, the motor 41 is a motor where the pole number is four and the slot number is six.

While the first embodiment to the third embodiment of the present invention have been described with reference to the drawings, the embodiments are not intended to limit concrete configurations, and may include modifications, combinations, deletions and the like without departing from the spirit and scope of the present invention. It goes without saying that the configurations described with reference to the embodiments may be combined, as appropriate.

For example, in the first embodiment to the third embodiment, the value obtained by dividing the least common multiple of the slot number and the pole number by the pole number may be an even number.

What is claimed is:

1. A motor comprising:
an armature including a plurality of non-wound teeth and a plurality of wound teeth having windings wound thereon, the plurality of non-wound teeth and the plurality of wound teeth being circumferentially alternately arranged about an axis; and
a field magnet including a plurality of magnets arranged side by side circumferentially so as to oppose one of an inner or an outer periphery of the armature, the field magnet being supported about the axis so as to be rotatable relative to the armature,
wherein:
the field magnet is provided with rotating force by sequentially switching a magnetic flux that flows through the non-wound teeth and the wound teeth due to energization of the windings of the armature; and
the wound teeth include a proximal-end portion having a circumferential width greater than a circumferential width of a proximal-end portion of the non-wound teeth.

2. The motor according to claim 1, wherein the circumferential width of the proximal-end portion of the non-wound teeth has a ratio of not less than 0.58 and not more than 0.85 to the circumferential width of the proximal-end portion of the wound teeth.

3. The motor according to claim 1, wherein a value obtained by dividing the least common multiple of a sum of the number of the plurality of non-wound teeth and the plurality of wound teeth and a number of magnetic poles of the plurality of magnets, by the number of magnetic poles of the plurality of magnets is an odd number.

4. The motor according to claim 1, wherein the field magnet is disposed on an outer peripheral side of the armature; and
the non-wound teeth of the armature protrude toward an outer peripheral side from the axis, include an outer peripheral end opposing the magnets of the field magnet, and include a magnetic path enlarged-portion that is circumferentially enlarged on the outer peripheral end side.

5. The motor according to claim 1, wherein:
the field magnet is disposed on an inner peripheral side of the armature; and
the non-wound teeth of the armature protrude toward the inner peripheral side from the axis, include an inner peripheral end opposing the magnets of the field magnet, and include a magnetic path enlarged-portion that is circumferentially enlarged on an outer peripheral end side.
